(19) United States
(12) Patent Application Publication
(10) Pub. No.: US 2026/0088474 A1
(43) Pub. Date: Mar. 26, 2026

(54) APPARATUS AND METHOD FOR MANUFACTURING SECONDARY BATTERY WITH ENHANCED ELECTROLYTE IMPREGNATION

(71) Applicant: SAMSUNG SDI CO., LTD., Yongin-si (KR)

(72) Inventor: Donghyun KIM, Yongin-si (KR)

(21) Appl. No.: 19/240,262

(22) Filed: Jun. 17, 2025

(30) Foreign Application Priority Data
Sep. 26, 2024 (KR) 10-2024-0130956

(51) Int. Cl. H01M 50/618

(52) U.S. Cl. CPC H01M 50/618

(57) ABSTRACT

An apparatus for manufacturing a secondary battery includes an impregnation chamber including a first pressure chamber and a second pressure chamber, the first pressure chamber being configured to accommodate a first gas room of the secondary battery, the second pressure chamber being configured to accommodate a second gas room of the secondary battery, and the secondary battery including a cell room accommodating an electrode assembly with an electrolyte, and a pressure generator, the impregnation chamber being configured to have magnitudes of internal pressures of the first pressure chamber and the second pressure chamber changeable by the pressure generator, such that the electrolyte accommodated in the secondary battery flows between the first gas room and the second gas room and the electrode assembly accommodated in the cell room of the secondary battery is impregnated with the electrolyte.

### CROSS-REFERENCE TO RELATED APPLICATION

The present application claims priority to and the benefit of Korean Patent Application No. 10-2024-0130956, filed on Sep. 26, 2024, in the Korean Intellectual Property Office, the entire disclosure of which is incorporated herein by reference.

### BACKGROUND

### 1. Field

The present disclosure relates to an apparatus and method for manufacturing a secondary battery having an increased electrolyte impregnation of an electrode assembly of the secondary battery and a shortened impregnation time.

### 2. Description of the Related Art

Batteries include primary batteries that cannot be recharged and secondary batteries that can be recharged or discharged. Low-capacity secondary batteries may be used in small portable electronic devices such as smartphones, feature phones, notebook computers, digital cameras, camcorders, etc., and large-capacity secondary batteries are widely used as power sources for driving motors in hybrid vehicles, electric vehicles, and the like, batteries for storing power, etc. A secondary battery may include an electrode assembly with a positive electrode and a negative electrode, an outer case such as a case, a can, or the like that accommodates the electrode assembly, an electrode terminal connected to the electrode assembly, etc.

The above information disclosed in this Background section is for enhancement of understanding of the background of the present disclosure, and therefore, it may contain information that does not constitute related (or prior) art.

### SUMMARY

According to an aspect of the present disclosure, there is provided an apparatus for manufacturing a secondary battery, which includes an impregnation chamber including a first pressure chamber in which a first gas room of a secondary battery is accommodated and a second pressure chamber in which a second gas room of the secondary battery is accommodated, wherein the secondary battery has a cell room in which an electrode assembly and an electrolyte are accommodated, a first gas room, and a second gas room, wherein the impregnation chamber is configured such that magnitudes of internal pressures of the first pressure chamber and the second pressure chamber are changed so that the electrolyte accommodated in the secondary battery flows between the first gas room and the second gas room and the electrode assembly accommodated in the cell room of the secondary battery is impregnated with the electrolyte.

According to another aspect of the present disclosure, there is provided a method of manufacturing a secondary battery, which includes manufacturing a secondary battery having a cell room in which an electrode assembly and an electrolyte are accommodated, and a first gas room and a second gas room that are connected to the cell room, accommodating the secondary battery in an impregnation chamber including a first pressure chamber and a second pressure chamber, wherein the first gas room is accommodated in the first pressure chamber and the second gas room is accommodated in the second pressure chamber, and changing magnitudes of internal pressures of the first pressure chamber and the second pressure chamber of the impregnation chamber and causing the electrolyte accommodated in the secondary battery to flow between the first gas room and the second gas room so that the electrode assembly accommodated in the cell room of the secondary battery to be impregnated with the electrolyte.

Features and aspects of the present disclosure is not limited to the above, and other features and aspects not specifically mentioned herein, and aspects of the present disclosure that would address such problems, will be clearly understood by those skilled in the art from the description of the present disclosure below.

### BRIEF DESCRIPTION OF THE DRAWINGS

Features will become apparent to those of skill in the art by describing in detail exemplary embodiments with reference to the attached drawings, in which:

FIGS. 1 and 2 schematically illustrate examples of an electrode assembly having a winding-type structure and a stack-type structure, respectively;

FIG. 3 schematically illustrates a pouch-type secondary battery;

FIGS. 4 to 6 illustrate stages in a process for manufacturing a secondary battery according to some embodiments of the present disclosure;

FIG. 7 illustrates an impregnation chamber according to some embodiments of the present disclosure;

FIG. 8 illustrates a front view of a secondary battery mounted in an impregnation chamber according to an embodiment;

FIG. 9 illustrates a configuration diagram of an impregnation chamber according to another embodiment;

FIG. 10 illustrates a view for describing an example in which electrolyte impregnation can be more easily performed in an impregnation chamber;

FIG. 11 illustrates an exemplary diagram of a secondary battery pack in which the secondary battery of the present disclosure is implemented; and

FIG. 12 illustrates an example of a vehicle in which a secondary battery pack is mounted.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe embodiments in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “linked to,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements. In addition, it will also be understood that when an element or layer is referred to as being “between” two elements or layers, it can be the only layer or element between the two layers or elements, or one or more intervening layers or elements may also be present.

In the figures, dimensions of the various elements, layers, etc. may be exaggerated for clarity of illustration. The same reference numerals designate the same elements throughout. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

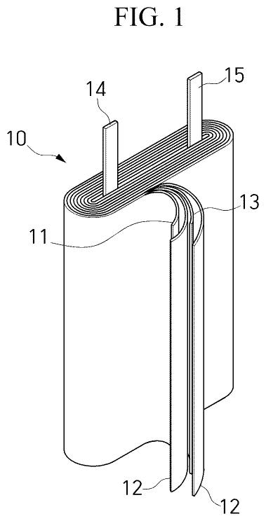

FIGS. 1 and 2 schematically illustrate examples of an electrode assembly having a winding-type structure and a stack-type structure, respectively.

For example, referring to FIG. 1, an electrode assembly 10 may be formed by winding a stack of a first electrode plate 11, a separator 12, and a second electrode plate 13, each of which are formed as thin plates or films. When the electrode assembly 10 is a wound stack, a winding axis of the stack may be parallel to the longitudinal direction of a case accommodating the electrode assembly 10. In another example, referring to FIG. 2, the electrode assembly 10 may be a stack type (rather than a winding type), formed by stacking the first electrode plate 11, the separator 12, and the second electrode plate 13. In yet another example, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case may be any suitable number. The first electrode plate 11 of the electrode assembly may act as a negative electrode, and the second electrode plate 13 may act as a positive electrode, e.g., the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, e.g., a polyethylene film, a polypropylene film, a polyethylene-polypropylene film, or the like.

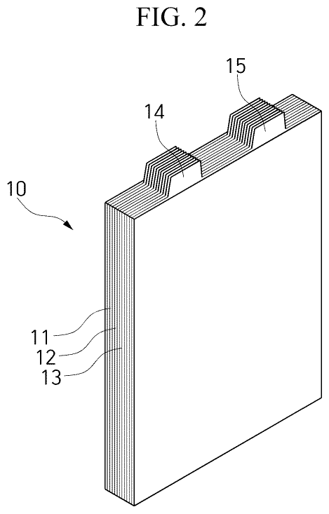

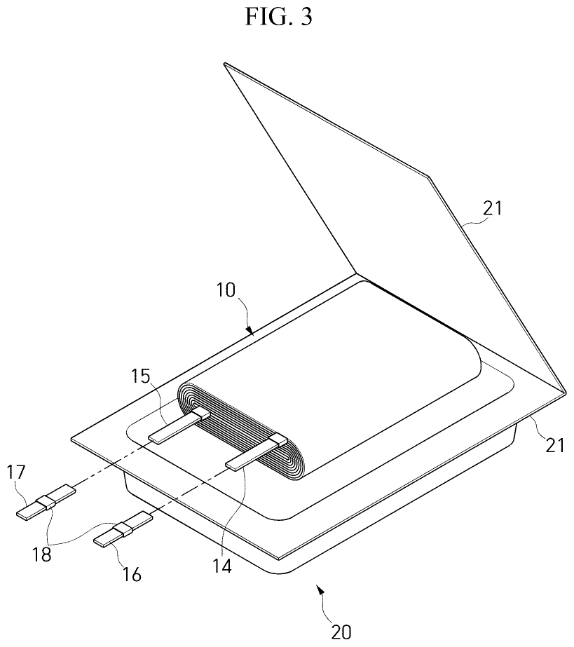

In some embodiments, the electrode assembly 10 may be accommodated in a case along with an electrolyte. In a pouch-type secondary battery, an electrode assembly 10 may be accommodated in a pouch made of flexible material (see, e.g., FIG. 3). In a cylindrical or prismatic secondary battery, the electrode assembly 10 may be accommodated in a cylindrical or prismatic metal casing (see, e.g., FIGS. 3 and 4).

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-c}D_{α} (0.90≤a≤1.8, 0≤b≤0.5, 0≤c≤0.5, 0<α<2); LiₐNi_{b}Co_{c}Li_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂(0.90≤a≤1.8, 0.001≤b≤0.1); LiₐMn_{1-b}GbO₂ (0.90≤a<1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8).

In the above formulas: A is Ni, Co, Mn, or a combination thereof, X is Al, Ni, Co, Mn, Cr, Fe, Mg, Sr, V, a rare earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al).

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

FIG. 3 schematically illustrates the pouch-type secondary battery.

Referring to FIG. 3, the pouch-type secondary battery may include the electrode assembly 10 and a pouch 20 that accommodates the electrode assembly 10. The electrode assembly 10 is the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by having sealing parts 21 as the edges thereof come into contact with each other while accommodating the electrode assembly 10 therein, in which case the sealing may be achieved with the tab film 18 interposed between the sealing parts 21. The sealing parts 21 of the pouch 20 may each be made of a thermal fusion material that generally has weak adhesion to metal. Thus, it may be fused to the pouch 20 by interposing the thin tab film 18 between the sealing parts 21.

In a comparative example, a cell accommodation part and a gas accommodation part may be formed in a pouch, an electrode assembly may be inserted into the cell accommodation part, and the pouch may be folded along a folding line over the electrode assembly. Two sides of the pouch (adjacent the folding line) may be sealed, leaving a single side of the pouch open. A region between the cell accommodation part and the gas accommodation part may be partially sealed, defining a cell room (which is a space in which the electrode assembly is accommodated) and a gas room (in which gas generated from the electrode assembly is collected) on opposite sides of the partially sealed region. An electrolyte may be injected through the open part of the pouch (adjacent the gas room) and enter the cell room through the partially sealed region between the cell room and the gas room, thereby penetrating between electrode plates of the electrode assembly mounted inside the cell room.

A certain amount of electrolyte (e.g., about 70% to 80% of the volume of the cell room) may be injected, and then the open part of the pouch may be sealed. Then, aging may be performed for a long period of time (e.g., about 24 hours to 30 hours), so that a gap between the electrode plates of the electrode assembly is uniformly impregnated with the electrolyte. Pressing may be performed while the electrode assembly is pre-charged to achieve inter-plate adhesion and solid electrolyte interphase (SEI) layer generation together with the aging or after the aging. During the pre-charging process, a large amount of gas may be generated, and thus the generated gas may be collected in the gas room (through the partially sealed region). After the gas collected in the gas room is degassed, the partially sealed region may be completely sealed and used as a cutting line to remove the gas room.

Through the above process of the comparative example, the electrode assembly may be accommodated in the pouch, the electrolyte may be injected, and the electrode assembly may be impregnated with the electrolyte. Local non-charging and side reactions due to the lifting or insufficient adhesion of the electrode plates during subsequent pre-charging and pressing may be reduced only when a gap between the electrode plates of the electrode assembly is uniformly impregnated with the electrolyte. However, the period of time required for the uniform electrolyte impregnation is long (e.g., due to the electrolyte flowing in only one direction), thereby increasing the period of time for which the secondary battery semi-finished products are placed on an aging rack. Therefore, the entire production line may increase due to the accumulated quantity of secondary battery semi-finished products.

In contrast, in the present disclosure, change in the shape of a secondary battery and a chamber for enhancing the impregnation of an electrolyte is proposed. That is, the present disclosure provides 1) a secondary battery having a structure in which a plurality of gas rooms are provided in the secondary battery so that the flow of gas (and thus the flow of an electrolyte) alternates in both directions of a cell room in which an electrode assembly is accommodated, and 2) an impregnation chamber having two pressure chambers in which the two gas rooms are accommodated, so that air pressure is applied to each gas room to provide a driving force for causing a two-way flow of electrolyte between each gas room and the cell room. As such, a uniform impregnation of the electrolyte and shortening of the required time may be provided. This structure of the secondary battery will be described in detail below with reference to FIGS. 4 to 6.

FIGS. 4 to 6 are diagrams of stages in a process for manufacturing a secondary battery according to some embodiments of the present disclosure.

Referring to FIG. 4, a pouch may be manufactured with a cell accommodation part 24 in which an electrode assembly 10 is to be accommodated and gas accommodation parts 26a and 26b formed on opposite sides of the cell accommodation part 24. The electrode assembly 10 may be inserted into the cell accommodation part 24, and the pouch may be folded in half along a folding line F, e.g., one half of the pouch may be folded over another half of the pouch to cover the electrode assembly 10.

Next, referring to FIG. 5, a portion of the pouch folded along the folding line F may be defined as a side 28, and two outer sides of the remaining sides of the pouch may be sealed. That is, as illustrated in FIG. 5, an upper sealing 30 may be performed. In addition, some parts of a connection part between the cell accommodation part 24 and a first gas accommodation part 26a may be sealed (34a and 34a′) to form a first connection neck 36a, and symmetrically, some parts of a connection part between the cell accommodation part 24 and a second gas accommodation part 26b may be sealed (34b and 34b′) to form a second connection neck 36b. Accordingly, a cell room 38 (which is a space in which the electrode assembly 10 is accommodated) and a first gas room 40a and a second gas room 40b (in which gas generated from the electrode assembly 10 is collected) may be formed. One side of the first gas room 40a (an opposite side relative to the cell room 38) and one side of the second gas room 40b (an opposite side relative to the cell room 38) may not be sealed and may be placed in the form of a first open part 42a and a second open part 42b, respectively. An electrolyte may be injected through one of the first and second open parts 42a and 42b. The electrolyte may enter the cell room 38 through a corresponding one of the first and second connection necks 36a and 36b between the cell room 38 and a corresponding one of the first and second gas rooms 40a and 40b, and may penetrate between electrode plates of the electrode assembly 10 mounted inside the cell room 38.

A certain amount of the electrolyte (e.g., about 70 to 80% of the volume of the cell room 38) may be injected, and then the first and second open parts 42a and 42b may be sealed (44a and 44b), as illustrated in FIG. 6. Then, aging may be performed so that a gap between the electrode plates of the electrode assembly 10 is uniformly impregnated with the electrolyte. Pressing may be performed while the electrode assembly 10 is pre-charged to achieve inter-plate adhesion and solid electrolyte interphase (SEI) layer generation together with the aging or after the aging.

When the electrolyte impregnation is completed, the first and second connection necks 36a and 36b between the cell room 38 and the first and second gas rooms 40a and 40b, respectively, may be completely sealed (e.g., parts 34a and 34a′ of the first connection neck 36a may be connected to each other to completely seal the region between the cell room 38 and the first gas room 40a, and parts 34b and 34b′ of the second connection neck 36b may be connected to each other to completely seal the region between the cell room 38 and the second gas room 40b). The first and second gas rooms 40a and 40b may be cut with the sealings as boundaries, and the first and second gas rooms 40a and 40b may be removed.

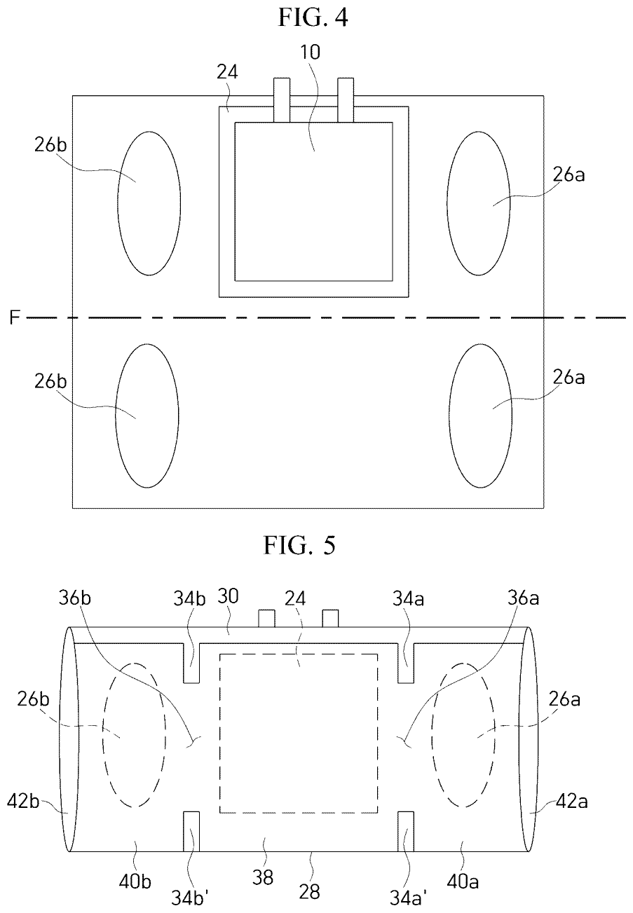

Next, the impregnation chamber will be described with reference to FIG. 7. FIG. 7 illustrates an impregnation chamber 50 according to some embodiments of the present disclosure.

Referring to FIG. 7, the secondary battery having the cell room 38, the first gas room 40a, and the second gas room 40b described above may be accommodated in the impregnation chamber 50. The impregnation chamber 50 may include a first pressure chamber 54a, in which the first gas room 40a of the secondary battery is accommodated, and a second pressure chamber 54b, in which the second gas room 40b of the secondary battery is accommodated. Optionally, the impregnation chamber 50 may additionally include a cell mounting chamber 52 in which the cell room 38 of the secondary battery is accommodated.

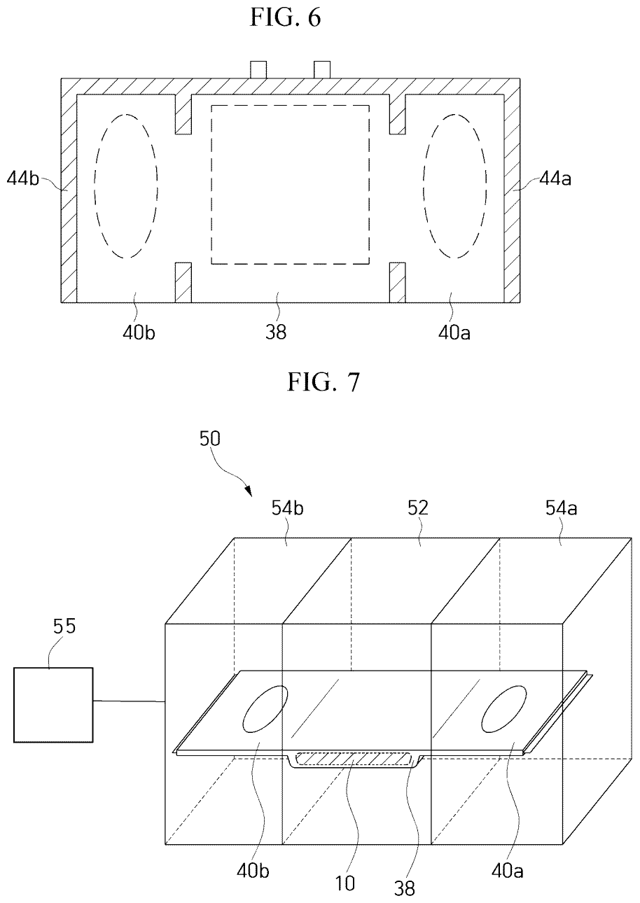

FIG. 8 is a front view of a secondary battery mounted in the impregnation chamber 50.

Referring to FIG. 8, a magnitude of an internal pressure Pa of the first pressure chamber 54a and a magnitude of an internal pressure Pb of the second pressure chamber 54b may be changed (e.g., independently changeable) by a pressure generating device 55 (e.g., a pressure generator). For example, the pressure generator may be a compressor (e.g., the pressure generator may be internal or external with respect to the impregnation chamber 50). An electrolyte that has been accommodated in the secondary battery may flow through the cell room 38 between the first gas room 40a and the second gas room 40b due to the pressures Pa and Pb changed in this way. That is, the flow of the electrolyte is induced by a pressure difference between the first pressure chamber 54a and the second pressure chamber 54b inside the impregnation chamber 50.

The magnitudes of the internal pressures of the first pressure chamber 54a and the second pressure chamber 54b may be controlled to be changed alternately. Therefore, different magnitudes of pressures may be alternately applied to the first gas room 40a and the second gas room 40b of the secondary battery. Accordingly, the electrolyte may flow from the first gas room 40a of the secondary battery to the second gas room 40b through the cell room 38 during a first time period, and flow from the second gas room 40b to the first gas room 40a through the cell room 38 during a second time period. For example, in FIG. 8, when Pa>Pb, the electrolyte may flow from the first pressure chamber 54a to the second pressure chamber 54b (i.e., from right to left in FIG. 8) due to the pressure difference, and when Pa<Pb, the electrolyte may flow from the second pressure chamber 54b to the first pressure chamber 54a (i.e., from left to right in FIG. 8). When Pa=Pb, the electrolyte may not flow in the previous state because the pressure is in an equilibrium state. When the electrolyte impregnation is completed, the pressures of the pressure chambers may be set to Pa=Pb and the secondary battery may be taken out of the impregnation chamber 50.

As described above, the gas chambers of the secondary battery may be provided in pairs, the electrode assembly may be positioned therebetween, and different pressures may be alternately applied to the respective gas rooms. Thus, the electrode assembly may be dynamically impregnated with the electrolyte, while the electrolyte flows in both directions in the electrode assembly, thereby achieving uniform impregnation and shortened impregnation time.

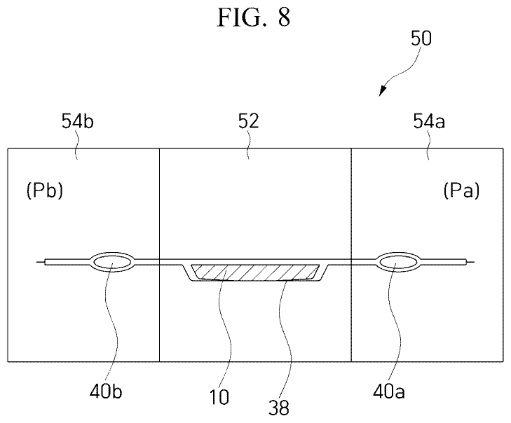

FIG. 9 is a configuration diagram of an impregnation chamber 50′ according to another embodiment.

Referring to FIG. 9, the impregnation chamber 50′ according to this embodiment may additionally include a presser 56 that presses an electrode assembly 10 accommodated in the cell room 38 of a secondary battery. As described above, the process of pre-charging the electrode assembly may be performed while the electrode assembly is pressed during the impregnation of the electrolyte, and thus in the embodiment of FIG. 9, the presser 56 for such a pressing and pre-charging process may be installed in the impregnation chamber 50′. Further, the electrode assembly may be heated during the pressing and pre-charging process (i.e., heat, press, and charge (HPC)) via an additionally installed heating device in the impregnation chamber 50′.

In FIG. 9, although the presser 56 is illustrated as being installed in a cell mounting chamber 52 of the impregnation chamber 50′, the presser 56 may be installed in the first pressure chamber 54a and/or the second pressure chamber 54b. Further, the heating device may also be installed in the cell mounting chamber 52 or in the first pressure chamber 54a and/or the second pressure chamber 54b.

When the electrolyte impregnation is completed, the secondary battery is taken out of the impregnation chamber 50′. In this case, as described above, the pressures of the pressure chambers are set to Pa=Pb and the secondary battery may be taken out. The first connection neck 36a between the first gas room 40a and the cell room 38 of the secondary battery taken out of the chamber after the electrolyte impregnation is completed is completely sealed, and the second connection neck 36b between the second gas room 40b and the cell room 38 is completely sealed. In this case, a sealing unit 58 (e.g., a sealer) may be used. In another example, the first and second connection necks 36a and 36b between the cell room 38 and the first and second gas rooms 40a and 40b, respectively, may be completely sealed while the secondary battery in which the electrolyte impregnation has been completed is not taken out of the impregnation chamber 50 and is mounted in the impregnation chamber 50′.

Next, the first and second gas rooms 40a and 40b may be cut with the first and second connection necks 36a and 36b between the sealed cell room 38 and the first and second gas rooms 40a and 40b as boundaries, and the first and second gas rooms 40a and 40b may be removed. In this case, a cutting unit 57 (e.g., a cutter) for cutting may be used. The process for cutting the first and second gas rooms may be performed while the secondary battery is placed in the impregnation chamber 50′ as described above.

The secondary battery described above may be a pouch-type secondary battery. However, in the case in which a gas room is required for a secondary battery made of a metal rather than a pouch, it is still possible to perform electrolyte impregnation as described above.

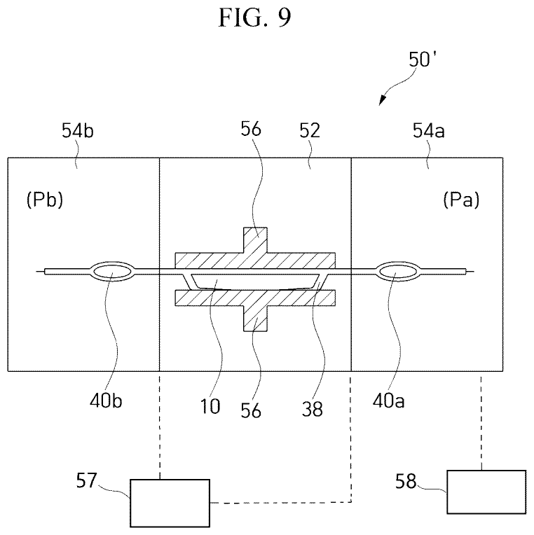

FIG. 10 is a view for describing an example in which electrolyte impregnation can be more easily performed in the impregnation chamber 50.

In FIGS. 8 and 9, the pressures of the first pressure chamber 54a and the second pressure chamber 54b of the impregnation chamber 50 act on the first gas room 40a and the second gas room 40b of the secondary battery to provide a driving force for flowing of the electrolyte between the cell room 38 and each of the first and second gas rooms 40a and 40b. In order to reduce the driving force in this case and cause smoother electrolyte flow, air holes 58a and 58b may be formed in the first gas room 40a and the second gas room 40b, respectively, in a secondary battery, as illustrated in FIG. 10. Accordingly, even when the pressures of first pressure chamber 54a and the second pressure chamber 54b are low, a fluid flow effect according to a pressure difference may be promoted due to the air holes 58a and 58b formed in the secondary battery, and thus smoother and more economical electrolyte impregnation may be performed.

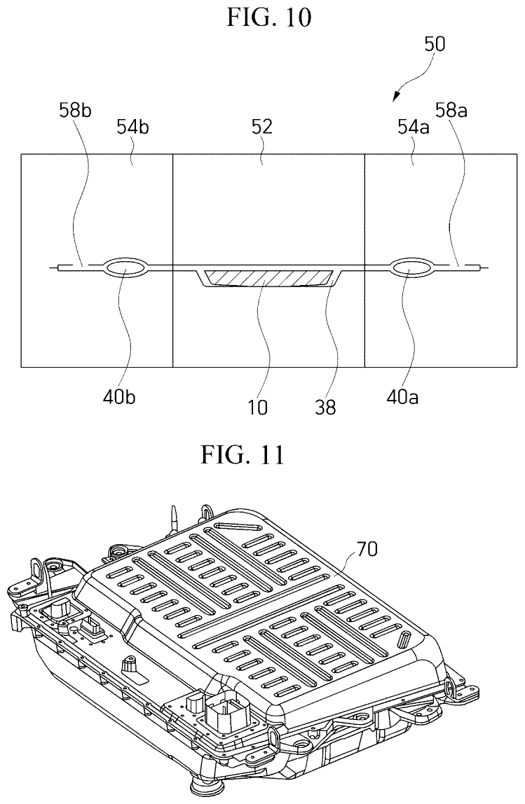

FIG. 11 is an exemplary diagram of a secondary battery pack in which the secondary battery of the present disclosure is used.

Referring to FIG. 11, a secondary battery pack 70 may be manufactured by embedding a plurality of secondary battery modules in a pack housing designed to be mounted on an actual product (e.g., a vehicle).

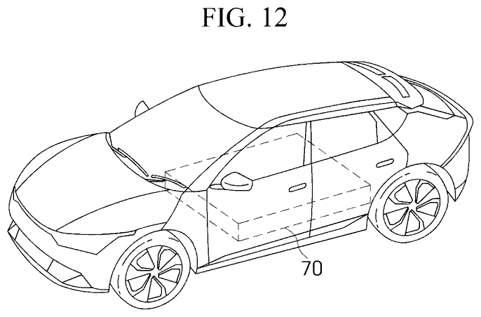

FIG. 12 illustrates an example of a vehicle equipped with a secondary battery pack.

Referring to FIG. 12, a vehicle V may be, e.g., an electric vehicle, a hybrid vehicle, a plug-in hybrid vehicle, or the like. The vehicle V may be a four-wheel drive vehicle or a two-wheel drive vehicle. FIG. 12 illustrates an example in which the secondary battery pack 70 is mounted on a lower body of the vehicle V.

By way of summation and review, when a secondary battery is manufactured, an electrode assembly may be accommodated inside an outer case of the secondary battery, and an electrolyte may be injected so that the electrode assembly is impregnated with the electrolyte. In this case, a gap between adjacent electrode plates of the electrode assembly should be uniformly impregnated with the electrolyte. In order to be uniformly impregnated with an electrolyte, since secondary battery semi-finished products should be placed on an aging rack for a long period of time, an impregnation time of the electrolyte increases, which causes the entire production line to become larger due to the accumulated quantity of secondary battery semi-finished products. In addition, it may not be easy to achieve uniform electrolyte impregnation even after long-term aging.

In contrast, the present disclosure is directed to an apparatus and method for manufacturing a secondary battery capable of increasing the electrolyte impregnation of an electrode assembly of the secondary battery and shortening an impregnation time. That is, according to the present disclosure, a secondary battery may include a plurality of gas rooms so that the flow of gas (and thus the flow of an electrolyte) alternates in both directions of the cell room, in which an electrode assembly is accommodated. An impregnation chamber may include two pressure chambers, in which the two gas rooms of the secondary battery are accommodated during electrolyte impregnation, so that air pressure is applied to each gas room to provide a driving force for causing a two-way flow of electrolyte between each gas room and the cell room, thereby increasing uniformity of electrolyte impregnation and shortening impregnation time.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for manufacturing a secondary battery, the apparatus comprising:
an impregnation chamber including a first pressure chamber and a second pressure chamber, the first pressure chamber being configured to accommodate a first gas room of the secondary battery, the second pressure chamber being configured to accommodate a second gas room of the secondary battery, and the secondary battery including a cell room accommodating an electrode assembly with an electrolyte; and
a pressure generator, the impregnation chamber being configured to have magnitudes of internal pressures of the first pressure chamber and the second pressure chamber changeable by the pressure generator, such that the electrolyte accommodated in the secondary battery flows between the first gas room and the second gas room and the electrode assembly accommodated in the cell room of the secondary battery is impregnated with the electrolyte.

2. The apparatus of claim 1, wherein the impregnation chamber further includes a cell mounting chamber between the first pressure chamber and the second pressure chamber, the cell mounting chamber being configured to accommodate the cell room of the secondary battery.

3. The apparatus of claim 2, wherein the cell mounting chamber of the impregnation chamber further includes a presser configured to press the electrode assembly accommodated in the cell room of the secondary battery.

4. The apparatus of claim 1, wherein the impregnation chamber is configured to have magnitudes of internal pressures of the first pressure chamber and the second pressure chamber alternately changeable, respectively, such that different magnitudes of pressures are alternately applied to the first gas room and the second gas room of the secondary battery.

5. The apparatus of claim 1, wherein the impregnation chamber further includes a presser configured to press the electrode assembly accommodated in the cell room of the secondary battery.

6. The apparatus of claim 1, further comprising a sealer between the cell room and each of the first gas room and the second gas room, the sealer being configured to seal the first gas room and the second gas room, after impregnation of the electrolyte of the electrode assembly accommodated in the secondary battery is completed.

7. The apparatus of claim 1, further comprising a cutter configured to remove the first gas room and the second gas room, after impregnation of the electrolyte of the electrode assembly accommodated in the secondary battery is completed.

8. The apparatus of claim 1, wherein the secondary battery is a pouch-type secondary battery.

9. A method of manufacturing a secondary battery, the method comprising:
manufacturing the secondary battery having a cell room in which an electrode assembly and an electrolyte are accommodated, and a first gas room and a second gas room that are connected to the cell room;
accommodating the secondary battery in an impregnation chamber including a first pressure chamber and a second pressure chamber, such that the first gas room is accommodated in the first pressure chamber and the second gas room is accommodated in the second pressure chamber; and
changing magnitudes of internal pressures of the first pressure chamber and the second pressure chamber of the impregnation chamber and causing the electrolyte accommodated in the secondary battery to flow between the first gas room and the second gas room so that the electrode assembly accommodated in the cell room of the secondary battery to be impregnated with the electrolyte.

10. The method of claim 9, wherein:
the impregnation chamber further includes a cell mounting chamber in which the cell room of the secondary battery is accommodated, and
the method further includes mounting the cell room of the secondary battery in the cell mounting chamber.

11. The method of claim 9, wherein changing the magnitudes of the internal pressures of the first pressure chamber and the second pressure chamber of the impregnation chamber includes alternately changing the magnitudes of the internal pressures of the first pressure chamber and the second pressure chamber to alternately apply different magnitudes of pressures to the first gas room and the second gas room of the secondary battery.

12. The method of claim 9, further comprising pressing the electrode assembly accommodated in the cell room of the secondary battery.

13. The method of claim 9, further comprising sealing between the first gas room and the cell room and sealing between the second gas room and the cell room, after impregnation of the electrolyte of the electrode assembly accommodated in the secondary battery is completed.

14. The method of claim 9, further comprising removing the first gas room and the second gas room, after impregnation of the electrolyte of the electrode assembly accommodated in the secondary battery is completed.

15. The method of claim 9, wherein accommodating the secondary battery in the impregnation chamber including the first pressure chamber and the second pressure chamber further includes forming an air hole in the first gas room of the secondary battery and forming an air hole in the second gas room.

16. The method of claim 9, wherein the secondary battery is a pouch-type secondary battery.

17. A secondary battery manufactured by the method of claim 9.
